(19) United States
(12) Patent Application Publication
(10) Pub. No.: US 2006/0058203 A1
(43) Pub. Date: Mar. 16, 2006

(54) Process for the preparation of pulverulent (poly)ureas

(76) Inventors: Wilhelm Laufer, Mannheim (DE); Michael Wuehr, Hirschberg (DE); Klaus Allgower, Ludwigshafen (DE); Patrick Galda, Karlsruhe (DE)

Correspondence Address: LANXESS CORPORATION, 111 RIDC PARK WEST DRIVE, PITTSBURGH, PA, 15275-1112, US

(21) Appl. No.: 11/198,788

(22) Filed: Aug. 5, 2005

(30) Foreign Application Priority Data
Aug. 11, 2004 (DE) 102004039156.4
Sep. 14, 2004 (DE) 102004044876.0

(51) Int. Cl. C10M 133/20; C08G 18/08

(52) U.S. Cl. 508/552; 564/61; 564/63; 528/48; 528/59; 528/60; 528/61

(57) ABSTRACT

The present invention relates to a process for the preparation of (poly)urea powders.

The present invention relates to a process for the preparation of (poly)urea powders and compositions which comprise the (poly)urea powders obtained by the process, and to the use of the polyurea particles obtained by the process as thickening agents, in particular in lubricants, such as so-called polyurea greases.

According to the prior art, so-called polyurea greases, which comprise polyureas as thickening agents in base oils, are still almost exclusively prepared by the so-called “in situ” process. In the “in situ” process, the polyurea thickener is produced “in situ” by polyaddition of polyisocyanate, dissolved in solvent or mineral oil, and polyamines, also dissolved in mineral oil or solvent. The polyurea obtained by this procedure is present in a divided, pre-swollen form and, after stripping off of the solvent, forms in the base oil (mineral oil) a gelatinous, structured paste, which forms a homogeneous grease after further homogenization. This process has the disadvantage that the product obtained contains impurities due to the reaction. TDI is particularly critical here. Particular approval procedures are therefore necessary for carrying out the “in situ” process. Further disadvantages are that the control of the reaction presents problems due to the high viscosities in the “in situ” process. Inhomogeneities may occur within the reaction masses. Furthermore, problems may arise in the removal of heat, since the polyaddition reaction proceeds exothermically. This so-called “in situ” prior art is referred to in detail in EP 0534248 A1, to which reference is made.

The process of EP 0534248 A1 attempts to overcome the disadvantages of the abovementioned prior art, in this process the polyaddition to give the polyurea first being carried out in a solvent (inter alia toluene, butanol, ethyl acetate, chloroform etc.) or without a solvent by extrusion. The solid obtained is subsequently reprocessed, i.e. dried (filtration with suction or evaporation or stripping off of the solvent), then ground and finally converted into the grease. In the process described in EP 0534248 A1, polyureas are first prepared by reaction of polyisocyanates with amines; when the components have reacted completely these products are then ground in the dry state to give powders, and the ground crude product is made into a paste in a base oil and processed to a “PU grease” in a high-pressure homogenizer under pressures of more than 500 bar. The disadvantage of this process is that the powders obtained by the grinding are relatively coarse-particled. This leads to disadvantages in the incorporation of the polyurea powders into the base liquids. The use of a high-pressure homogenizer is therefore obligatory in this process. The process thus requires a high input of energy. The process of EP 0534248 A1 furthermore has the disadvantage that several reactors and several process steps are necessary. The solvent variant of EP 0534248 A1 moreover requires very large amounts of solvent, which must be distilled off again after the reaction. High amounts of solvent are necessary, for example, so that the reaction product formed can be transported to a suction filter for drying. All this leads to a relatively high consumption of energy and relatively high solvent recycling costs. The solvent-free variant by extrusion has the disadvantage that problems may occur in the removal of heat (in particular cracking). In both variants, subsequent grinding of the dried reaction product is necessary, which also requires a very high outlay.

Similarly, the process of WO 02/04579, with which a polyurea grease having low noise properties is said to be provided, requires first a separate process for the preparation of the polyurea and then an additional shearing process with which the particle size of the thickener particles during incorporation into a base oil can be reduced to less than 500 nm.

Preferably, the particle sizes are reduced by the shearing process to the extent that all the particles are less than 100 μm, with 95% of the particles being less than 50 μm. However, preparation of even more fine-particled polyurea suspensions is not possible with an acceptable input of energy by the processes described there. WO 02/04579 moreover describes no finely divided dried polyurea powders which can be incorporated, for example, into base oils by customers on site.

WO 02/02683 furthermore discloses rubber compositions which comprise a finely divided polyurea filler. The polyurea filler particles used here have a particle size, determined by light microscopy, of 0.001 to 500 μm. However, the polyurea particles are not isolated, but are preferably prepared in the presence of the rubber. A dried finely divided polyurea powder, a process for its preparation and the use thereof as a thickener in so-called PU greases are not mentioned.

The present inventors have succeeded, completely surprisingly, in preparing particularly finely divided (poly)urea powders by the use of a process for the preparation of polyurea in a reactor with simultaneous exposure to shearing forces and removal of the volatile contents. The process allows the preparation of finely divided, dry (poly)urea powders in a single reactor without an additional grinding step. The (poly)urea particles obtained are sufficiently finely divided and allow incorporation into base oils for the preparation of (poly)urea greases without an increased consumption of energy.

By the use of the more finely divided particles, in the case in particular of incorporation into base oils for the preparation of so-called PU greases, the use of lower pressures during the homogenization is possible, which leads to savings in energy and materials.

The present invention thus relates to a process for the preparation of a (poly)urea powder, characterized in that at least one isocyanate is reacted with at least one amine in at least one solvent in a reactor and the (poly)urea formed is dried in the said reactor under exposure to shearing forces to form a (poly)urea powder. According to the invention, (poly)urea includes monourea compounds and polyurea compounds. Monourea compounds are those which contain a 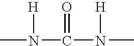
group in the molecule, wherein the free valencies are saturated by at least one organic group, urea itself thus being excluded. However, the polyurea compounds which contain at least two 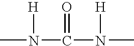
groups in the molecule are preferred according to the invention.

The present invention preferably relates to a process for the preparation of a polyurea powder, characterized in that at least one polyisocyanate is reacted with at least one polyamine and optionally with at least one monoamine and the polyurea formed is dried in the said reactor under exposure to shearing forces to form a polyurea powder.

Preferably, the weight ratio of the total weight of polyisocyanate and mono- and polyamine to the total weight of the solvents is from 10% to 50%. The ratio is particularly preferably from 15% to 35%. A ratio of greater than 50% is a disadvantage, because the thickening of the suspension during the reaction increasingly impedes the diffusion and reaction of the reaction partners. A ratio of less than 10% is a disadvantage because the yield is uneconomical.

The solvent used in the suspension employed according to the invention is preferably chosen from organic solvents. The solvent is particularly preferably chosen from organic solvents which are chosen from the group which consists of optionally substituted straight-chain, branched or cyclic aliphatic or aromatic hydrocarbons, such as butane, pentane, n-hexane, cyclohexane, n-octane, isooctane, petroleum ether, benzene, toluene, xylene, halogenated hydrocarbons, such as methylene chloride and chlorobenzene, ethers, such as diethyl ether and tetrahydrofuran, ketones, such as acetone, esters, such as ethyl acetate and butyl acetate etc.

n-Hexane, n-heptane, petroleum ether and ethyl acetate are particularly preferred solvents.

Solvents which are particularly preferred for foodstuffs uses are the solvents listed in the US legislation “Code of Federal Regulations” CFR 21 §§ 170-199, such as e.g. isoparaffinic petroleum ethers according to § 173.280, hexane according to § 173.270, acetone according to § 173.210, ethyl acetate according to § 173.228 and 1,3-butylglycol according to § 172.712.

It is also possible to use mixtures of one or more solvents.

The preparation of the polyurea can be carried out in a manner known per se by reaction of at least one polyisocyanate with at least one polyamine in a suitable solvent.

The preparation of the polyureas is expediently carried out by reaction of at least one polyisocyanate with at least one mono- or polyamine at temperatures of from −100 to 250° C., preferably 20 to 80° C., in a solvent, such as those mentioned above, with precipitation of the polyurea.

The polyureas obtained preferably have melting or decomposition points of ≧180° C., preferably ≧200° C., particularly preferably ≧240° C. Their glass transition temperatures, if they exist, are above 50° C., preferably above 100° C.

Suitable polyisocyanates for the preparation of the polyureas are e.g. hexamethylene-diisocyanate (HDI), toluene-diisocyanate (TDI), 2,2′-, 2,4′- and 4,4′-diisocyanatodiphenylmethane (MDI), polymethylenepolyphenyl isocyanate (PMDI), naphthalene-diisocyanate (NDI), 1,6-diisocyanato-2,2,4-trimethylhexane, isophorone-diisocyanate(3-isocyanato-methyl)-3,5,5-trimethylcyclohexyl isocyanate, IPDI), tris(4-isocyanato-phenyl)-methane, phosphoric acid tris-(4-isocyanato-phenyl ester), thiophosphoric acid tris-(4-isocyanato-phenyl ester) and oligomerization products which have been obtained by reaction of the low molecular weight diisocyanates mentioned with diols or polyalcohols, in particular ethylene glycol, 1,4-butanediol, 1,6-hexanediol, trimethylolpropane and pentaerythritol, and have a residual content of free isocyanate groups, and furthermore oligomerization products which have been obtained by reaction of the low molecular weight diisocyanates mentioned with polyesters containing hydroxyl groups, such as e.g. polyesters based on adipic acid and butanediol and hexanediol having molecular weights of from 400 to 3,000, or by reaction with polyethers containing hydroxyl groups, such as polyethylene glycols, polypropylene glycols and polytetrahydrofurans having molecular weights of from 150 to 3,000, and can have a residual content of free isocyanate groups, and furthermore oligomerization products which have been obtained by reaction of the low molecular weight diisocyanates mentioned with water or by dimerization or trimerization, such as e.g. dimerized toluene-diisocyanate (Desmodur TT) and trimerized toluene-diisocyanate, and aliphatic polyuretdiones containing isocyanate groups, e.g. based on isophorone-diisocyanate, and have a residual content of free isocyanate groups. Preferred contents of free isocyanate groups of the polyisocyanates are 2.5 to 50 wt. %, preferably 10 to 50 wt. %, particularly preferably 15 to 50 wt. %. Such polyisocyanates are known and are commercially obtainable. In this context see Houben-Weyl, Methoden der Organischen Chemie, volume XIV, pages 56-98, Georg Thieme Verlag Stuttgart 1963, Encyclopedia of Chem. Technol., John Wiley 1984, vol. 13, pages 789-818, Ullmann's Encyclopedia of Industrial Chemistry, VCH, Weinheim, 1989, vol. A 14, pages 611-625, and the commercial products of the Desmodur and Crelan series (Bayer AG).

Blocked polyisocyanates which can react with the polyamines under the reaction conditions mentioned are also suitable polyisocyanates. These include all the polyisocyanates already mentioned, the isocyanate groups in each case being blocked with suitable groups which can be split off, which are split off again at a higher temperature and liberate the isocyanate groups. Suitable groups which can be split off are, in particular, caprolactam, malonic acid esters, phenol and alkylphenols, such as e.g. nonylphenol, as well as imidazole and sodium hydrogen sulfite. Polyisocyanates blocked with caprolactam, malonic esters and alkylphenol, in particular based on toluene-diisocyanate or trimerized toluene-diisocyanate, are particularly preferred. Preferred contents of blocked isocyanate groups are 2.5 to 30%. Such blocked polyisocyanates are known and are commercially obtainable. In this context see Houben-Weyl, Methoden der Organischen Chemie, volume XIV, pages 56-98, Georg Thieme Verlag Stuttgart 1963, and the commercial products of the Desmodur and Crelan series (Bayer AG).

Preferred polyisocyanates are hexamethylene-diisocyanate (HDI), toluene-diisocyanate (TDI), 2,4′- and 4,4′-diisocyanatodiphenylmethane (MDI), polymethylenepolyphenyl isocyanate (PMDI), 1,6-diisocyanato-2,2,4-trimethylhexane, isophorone-diisocyanate (IPDI) and oligomerization products which have been obtained by reaction of the low molecular weight diisocyanates mentioned with water or with diols or polyalcohols, in particular ethylene glycol, 1,4-butanediol, 1,6-hexanediol, trimethylolpropane and pentaerythritol, and have a residual content of free isocyanate groups, as well as oligomerization products which have been obtained by dimerization or trimerization, such as dimerized toluene-diisocyanate (Desmodur TT) and trimerized toluene-diisocyanate, and aliphatic polyuretdiones containing isocyanate groups, e.g. based on isophorone-diisocyanate, and have a content of free isocyanate groups of 2.5 to 50 wt. %, preferably 10 to 50 wt. %, particularly preferably 15 to 35 wt. %. 2,4′- and 4,4′-diisocyanatodiphenylmethane (MDI), hexamethylene-diisocyanate (HDI), toluene-diisocyanate (TDI) and polymethylenepolyphenyl isocyanate (PMDI) are very particularly preferred.

Suitable polyamines are aliphatic di- and polyamines, such as hydrazine, ethylenediamine, 1,2-propylenediamine, 1,3-propylenediamine, 1-amino-3-methylaminopropane, 1,4-diaminobutane, N,N′-dimeth-1-ethylenediamine, 1,6-diaminohexane, 1,12-diaminododecane, 2,5-diamino-2,5-dimethylhexane, trimethyl-1,6-hexane-diamine, diethylenetriamine, N,N′,N″-trimethyldiethylenetriamine, triethylenetetraamine, tetraethylenepentamine, pentaethylenehexamine, polyethyleneimine having molecular weights of between 250 and 10,000, dipropylenetriamine, tripropylenetetraamine, bis-(3-aminopropyl)amine, bis-(3-aminopropyl)-methylamine, piperazine, 1,4-diaminocyclohexane, isophoronediamine, N-cyclohexyl-1,3-propanediamine, bis-(4-amino-cyclohexyl)methane, bis-(4-amino-3-methyl-cyclohexyl)-methane, bisaminomethyltricyclodecane (TCD-diamine), o-, m- and p-phenylenediamine, 1,2-diamino-3-methylbenzene, 1,3-diamino-4-methylbenzene(2,4-diaminotoluene), 1,3-bisaminomethyl-4,6-dimethylbenzene, 2,4- and 2,6-diamino-3,5-diethyltoluene, 1,4- and 1,6-diaminonaphthalene, 1,8- and 2,7-diaminonaphthalene, bis-(4-amino-phenyl)-methane, polymethylenepolyphenylamine, 2,2-bis-(4-aminophenyl)-propane, 4,4′-oxybisaniline, 1,4-butanediol bis-(3-aminopropyl ether), polyamines containing hydroxyl groups, such as 2-(2-aminoethylamino)ethanol, polyamines containing carboxyl groups, such as 2,6-diamino-hexanoic acid, and furthermore liquid polybutadienes or acrylonitrile/butadiene copolymers which contain amino groups and have average molecular weights of preferably between 500 and 10,000 and polyethers containing amino groups, e.g. based on polyethylene oxide, polypropylene oxide or polytetrahydrofuran and having a content of primary or secondary amino groups of from 0.25 to approx. 8 mmol/g, preferably 1 to 8 mmol/g. Such polyethers containing amino groups are commercially obtainable (e.g. Jeffamin D-400, D-2000, DU-700, ED-600, T-403 and T-3000 from Texaco Chem. Co.).

Particularly preferred polyamines are hydrazine, ethylenediamine, 1,2-propylenediamine, 1,3-propylenediamine, 1-amino-3-methylaminopropane, 1,4-diaminobutane, N,N′-dimethyl-ethylenediamine, 1,6-diaminohexane, diethylenetriamine, N,N′,N″-trimethyldiethylenetriamine, triethylenetetraamine, tetraethylenepentamine, pentaethylenehexamine, polyethyleneimine having molecular weights of between 250 and 10,000, dipropylenetriamine, tripropylenetetraamine, isophoronediamine, 2,4-diaminotoluene and 2,6-diaminotoluene, bis-(4-amino-phenyl)-methane, polymethylene-polyphenylamine and liquid polybutadienes or acrylonitrile/butadiene copolymers which contain amino groups and have average molecular weights of preferably between 500 and 10,000 and polyethers containing amino groups, e.g. based on polyethylene oxide or polypropylene oxide, having a content of primary or secondary amino groups of from 1 to 8 mmol/g.

Very particularly preferred polyamines are ethylenediamine, 1,2-propylenediamine, 1,3-propylenediamine, diethylenetriamine, triethylenetetraamine, tetraethylenepentamine, pentaethylenehexamine, polyethyleneimine having molecular weights of between 250 and 10,000, 2,4-diaminotoluene and 2,6-diaminotoluene, bis-(4-amino-phenyl)-methane and polymethylenepolyphenylamine as well as polyethers containing amino groups, e.g. based on polyethylene oxide or polypropylene oxide, having a content of primary or secondary amino groups of from 1 to 8 mmol/g and molecular weights of between 250 and 2,000.

In addition to the polyamines, further compounds which are reactive towards the polyisocyanates can also be added, in particular chain termination agents, such as monoamines, such as ammonia, C1 to C18-alkylamines and di-(C1 to C18-alkyl)-amines, as well as arylamines, such as aniline, C1-C12-alkylarylamines, and aliphatic, cycloaliphatic or aromatic mono-, di- or poly-C1- to C18-alcohols, aliphatic, cycloaliphatic or aromatic mono-, di- or poly-C1 to C18-carboxylic acids, aminosilanes, such as 3-aminopropyltrimethoxysilane and 3-aminopropyltriethoxysilane, as well as liquid polybutadienes or acrylonitrile/butadiene copolymers which contain carboxyl, epoxide or hydroxyl groups and have average molecular weights preferably of between 500 and 10,000 and polyethers and polyesters having molecular weights of between 200 to 10,000, which have hydroxyl and/or carboxyl groups which are reactive towards the polyisocyanates. Examples of these monoamines which are additionally to be used are ammonia, methylamine, dimethylamine, dodecylamine, octadecylamine, oleylamine, stearylamine, ethanolamine, diethanolamine, beta-alanine or aminocaproic acid. The amount of these additional amines, alcohols, carboxylic acids and polyethers and polyesters containing hydroxyl and/or carboxyl groups depends on their content of groups which are reactive towards the polyisocyanates and is 0 to 0.5 mol of reactive group per isocyanate equivalent.

The polyurea particles according to the invention can be prepared—as mentioned—by reaction of at least one polyisocyanate with at least one mono- or polyamine at temperatures of from −100 to 250° C., preferably 20 to 80° C., in a solvent with precipitation of the polyurea. Preferred solvents are, in particular, organic, preferably aprotic solvents which are not reactive with isocyanates, in particular optionally substituted straight-chain, branched or cyclic, aliphatic or aromatic hydrocarbons, such as butane, pentane, n-hexane, petroleum ether, cyclohexane, n-octane, isooctane, benzene, toluene, xylene, halogenated hydrocarbons, such as methylene chloride and chlorobenzene, ethers such as diethyl ether and tetrahydrofuran, ketones, such as acetone, esters such as ethyl acetate and butyl acetate etc.

Solvents which are particularly preferred for foodstuffs uses are, as already mentioned above: isoparaffinic petroleum ether, hexane, acetone, ethyl acetate and 1,3-butylglycol.

The monourea compounds are prepared in a manner corresponding to the polyurea compounds, in particular by reaction of monofunctional isocyanates with monofunctional amines. These are expediently those compounds which have a thickening action on the base oils similarly to the polyureas.

In contrast to the so-called “in situ” prior art described above, according to the invention the preparation of the (poly)urea particles is not carried out in the so-called basic or base oil of the lubricant, as is described below. The solvents which are used for the preparation of the polyureas and which are present in the suspensions subjected to the spray drying differ from the so-called base oils in particular by their viscosity and their molecular weight. The viscosity of the solvents is about up to 1 cSt (40° C.), while in the case of the base oils it is at least about 4, preferably at least about 5 cSt (40° C.). Base oils have a molecular weight distribution which results, due to their preparation, from the refining/distillation. In contrast, solvents have a defined molecular weight.

The reaction of polyisocyanate with mono- or polyamine is preferably carried out such that the polyisocyanate is initially introduced into the solvent and the polyamine is then mixed in, or by initially introducing the mono- or polyamine into the solvent and mixing in the polyisocyanate. The amounts of polyisocyanate and mono- or polyamine depend on the desired properties of the polyurea particles. By employing an excess of mono- or polyamine, these particles contain, for example, still-bonded amino groups, or if an excess of polyisocyanate is employed they contain still-bonded isocyanate groups.

Preferred amounts ratios of polyisocyanate and polyamine are 0.5 to 2.0, more preferably 0.7 to 1.3, in particular 0.8 to 1.2 mol of isocyanate group per mol of amino group.

If monoamines, such as stearylamine, are used as a chain stopper, this can influence the ratios of polyamine to polyisocyanate accordingly.

In addition to mono- or polyamines, further polyfunctional compounds which are reactive towards isocyanates can be used according to the invention, such as, for example, in particular polyols, so that the formation of polyurea-urethanes occurs. Such polyols can also contain polyether groups. The polyols can be, for example, the abovementioned polyalcohols employed for the preparation of oligomeric polyisocyanates.

As already mentioned above, emulsifiers and dispersing agents can be added before or during the preparation process to control the polyurea particle size.

According to the invention, the polyureas are those which contain at least two recurring urea units of the formula

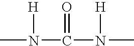

According to the invention, polyureas which contain on average two, three or four such urea groups are particularly preferred.

The polyurea particles preferably comprise polyurea having a weight-average molecular weight, determined by gel permeation chromatography against polystyrene as the standard, of from 500 to 20,000.

Particularly preferred polyureas are reaction products of 2,4′- and 4,4′-diisocyanatodiphenylmethane (MDI), hexamethylene-diisocyanate (HDI), toluene-diisocyanate (TDI) and polymethylenepolyphenyl isocyanate (PMDI) and ethylenediamine, 1,2-propylenediamine, 1,3-propylenediamine, 2,4-1,6-diaminohexane, diaminotoluene and 2,6-diaminotoluene, bis-(4-amino-phenyl)-methane and polymethylenepolyphenylamine and/or monoamines, such as ammonia, C1 to C18-alkylamines and di-(C1 to C18-alkyl)-amines, as well as arylamines, such as aniline, and C1-C12-alkylarylamines, as well as polyureas having molecular weights of from 500 to 3,000.

When the reaction to give the (poly)urea has ended, drying of the (poly)urea powder is carried out by stripping off the solvent and the remaining volatile constituents which may be present from the reaction reactor. The drying is preferably carried out at a temperature in the range from 40 to 80° C. In a preferred variant, the drying is carried out under a reduced pressure of preferably less than 300 mbar. The drying is particularly preferably carried out under a pressure in the range of from 10 to 180 mbar.

The process according to the invention is characterized in that at least the drying step is carried out under exposure to shearing forces. Exposure to shearing forces means that shearing forces are exerted on the (poly)urea particles in the reactor. The exposure to shearing forces is preferably also already applied during the reaction of the polyisocyanate with the polyamine, as a result of which the formation of larger particles or agglomerates is avoided from the beginning.

The shearing forces exerted in the reactor are preferably from 1 to 10⁴·s⁻¹.

The exposure to shearing forces during the drying and optionally also during the reaction is expediently chosen such that the particle size ranges stated below for the (poly)urea powder obtained are achieved.

Suitable reactors in which the preparation and drying of the (poly)urea powders can be carried out under exposure to shearing forces preferably include horizontal single-shaft mixers.

The dry polyurea powders obtained by the process according to the invention preferably have a residual content of volatile constituents (those which have a boiling point of less than 250° C.) of less than 5 wt. %, more preferably less than 3 wt. %, even more preferably less than 1 wt. %.

The dry (poly)urea powders obtained by the process according to the invention preferably have average particle sizes of less than 150 μm, preferably less than 100 μm and even more preferably of less than 80 μm. The lower limit of the average grain or particle size is preferably more than about 20 μm. Grain sizes of more than 150 μm are less preferred, since these make homogeneous incorporation of the (poly)urea particles into the basic or base oils difficult. Average particle sizes of less than 20 μm are less preferred, because they would require to high an expenditure on shear, and on the other hand the finely divided powder then tends towards a greater formation of dust.

The average grain size here means the weight-average of the particle size, and it is determined by coherent light scattering (laser method). This method provides an average particle size, including the agglomerates. The size of the primary particles can be considerably lower, for example about 1 to 10 μm. A substantial deagglomeration of the polyurea particles prepared according to the invention can be achieved by the use of high-pressure homogenizers on the PU greases prepared according to the invention.

Preferably, more than 90% of the particles of the (poly)urea powder obtained have a particle size of less than 100 μm.

The present invention furthermore relates to dry (poly)urea powders which are obtainable by the process according to the invention, and in particular also the dried (poly)urea powders which have an average particle diameter of 20 to 150 μm, preferably 20 to 100 μm, the solvent content of which is preferably less than 0.5 wt. %, more preferably less than 0.3 wt. %, even more preferably less than 0.2 wt. %.

The advantage of the dry (poly)urea powders prepared according to the invention is in particular that for the first time a possibility has been found which enables customers to prepare so-called PU greases without having to use “in situ” processes, which are problematic from the point of view of work safety, or having to use a high-pressure homogenization under high pressures of more than 500 bar. It is therefore to be expected that the (poly)urea particles obtainable by the process according to the invention will open up fields of use or customer circles for which the use of (poly)ureas had not hitherto been considered because of the disadvantages described.

The (poly)urea powders obtainable by the process according to the invention are, in particular, those having a high specific surface area. Such high specific surface areas are not obtainable by other drying processes which are conventional in the prior art and subsequent grinding. The (poly)urea powders according to the invention have a specific surface area of from 15 to 50 m²/g, preferably from 35 to 45 m²/g (measured by Hg porosimetry).

The present invention furthermore relates to a process for the preparation of a composition which comprises the (poly)urea powders described above suspended in at least one base oil.

In this context, base oils in principle include any preferably organic liquid which is inert towards the (poly)urea powder. In particular, they are those liquids which can thicken by means of the (poly)urea powder.

Preferred base oils are, for example, conventional base oils employed in lubricants, such as the conventional mineral oils, synthetic hydrocarbon oils or synthetic or natural ester oils used, or mixtures thereof. In general, these have a viscosity in the range of from about 4, preferably 5, to about 400 cSt at 40° C., although typical uses require a viscosity in the range of from about 10 to approximately 200 cSt at 40° C. Mineral oils which can be employed according to the invention can be conventional refined base oils which are derived from paraffinic, naphthenic or mixed crude oils. Synthetic base oils include ester oils, such as esters of glycols, such as a C13 oxo acid diester of tetraethylene glycol, or complex esters, such as those which are formed from 1 mol of sebacic acid and 2 mol of tetraethylene glycol and 2 mol of 2-ethylhexanoic acid.

Natural ester oils include saturated and unsaturated natural ester oils, such as plant or animal oils and fats, which are the known triglycerides of naturally occurring fatty acids, and hydrogenated products or transesterification products thereof. Preferred such natural ester oils are of plant origin, in particular plant oils, which substantially comprise mixed glycerol esters of higher fatty acids having an even number of carbon atoms, such as, for example, apricot kernel oil, avocado oil, cotton oil, borage oil, thistle oil, groundnut oil, hydrogenated groundnut oil, cereal germ oil, hemp oil, hazelnut oil, pumpkin kernel oil, coconut oil, linseed oil, bay oil, poppy-seed oil, macadamia oil, maize oil, almond oil, evening primrose oil, olive oil, hydrogenated palm oil, palm oil, pistachio kernel oil, rape oil, castor oil, sea buckthorn oil, sesame oil, soya oil, sunflower-seed oil, grape-seed oil, walnut oil, wheat germ oil, wild rose oil, coconut fat, palm fat, palm kernel fat or colza oil. Sunflower oil, soya oil and rape oil are preferred.

Other synthetic oils include: synthetic hydrocarbons, such as poly-alpha-olefins, alkylbenzenes, such as e.g. alkylate bottom products from the alkylation of benzene with tetrapropylene, or the copolymers of ethylene and propylene; silicone oils, e.g. ethylphenylpolysiloxanes, methylpolysiloxanes etc., polyglycol oils, e.g. those obtained by condensation of butyl alcohol with propylene oxide; carbonic acid esters, e.g. the product of the reaction of C8 oxo alcohols with ethyl carbonate to form a half-ester, followed by reaction with tetraethylene glycol, etc. Other suitable synthetic oils include polyphenyl ethers, such as those which contain approximately 3 to 7 ether bonds and approximately 4 to 8 phenyl groups. Further base oils include perfluorinated polyalkyl ethers, such as those described in WO 97/477710.

The base oils preferably have a boiling point of more than 100° C., more preferably more than 150° C., even more preferably more than 180° C. Preferred base oils are conventional refined base oils which are derived from paraffinic, naphthenic or mixed crude oils, synthetic hydrocarbons, such as poly-alpha-olefins and alkylbenzenes, and ester oils.

Base oils which are particularly preferred for foodstuffs uses are the base oils listed in the US legislation “Code of Federal Regulations” CFR 21 §§ 170-199, such as e.g. white oil according to § 172.878, isoparaffinic hydrocarbons according to § 178.3530, mineral oil according to § 178.3620, polyethylene glycols according to § 178.3750 and fatty acid methyl/ethyl esters according to § 172.225.

Preferably, the composition prepared according to the invention comprises from 2 to 25 wt. %, preferably from 5 to 15 wt. % of the (poly)urea according to the invention, based on the total amount of the base oil.

The process for the preparation of the abovementioned composition expediently comprises suspension of the (poly)urea powder prepared according to the invention in at least one base oil. The suspending of the (poly)urea powder in the base oil can be carried out in a manner known per se, for example in a homogenizer or by means of a roll mill or high-speed dissolvers as well as further devices known per se for the preparation of such dispersions, such as, for example, corundum discs, colloid mills, pinned disc mills etc. The incorporation of the powder is carried out by preparing a paste at elevated temperatures of approx. 100-220° C., preferably of from approx. 120 to 200° C., and then homogenizing the mixture once to several times in the abovementioned apparatuses. In particular, incorporation at elevated temperatures optionally up to approx. 200° C., subsequent cooling and homogenization several times (two or more) has proved to be particularly preferred. It has proved expedient to cool the paste mass before the homogenization. As mentioned above, if required it is possible for the (poly)urea particles obtained according to the invention to be deagglomerated further during the preparation of the PU greases by the sole or additional use of a high-pressure homogenizer, such as a so-called APV homogenizer, and thereby to further lower the average particle sizes down to the primary particle size range. By the use of the particularly finely divided (poly)urea powder according to the invention of high specific surface area, the incorporation of the polyurea powder requires substantially less energy than the incorporation of a (poly)urea powder prepared by means of grinding. Moreover, lower amounts of the polyurea powder are required to achieve the same viscosities.

The present invention furthermore relates to the use of the (poly)urea powders prepared according to the invention as thickening agents. The (poly)urea powders according to the invention can be utilized, for example, as thickening agents in the following uses: paints, lacquers, adhesives, pastes, greases, solutions, foodstuffs uses or foodstuffs compositions etc.

The (poly)urea powders prepared according to the invention are particularly preferably used as thickening agents in lubricants.

In this context, the polyurea powders prepared according to the invention are preferably used in amounts of from about 5 to 25 wt. %, based on the total amount of the base oil.

The present invention furthermore relates to lubricants which comprise the polyurea powders prepared according to the invention, at least one base oil and optionally further conventional auxiliary substances and additives for lubricants. These conventional auxiliary substances and additives include, for example: corrosion inhibitors, high-pressure additives, antioxidants, friction modifiers and wearing protection additives.

A description of the additives used in lubricating greases is to be found, for example, in Boner, “Modern Lubricating Greases”, 1976, chapter 5.

In a particular embodiment, the invention relates to a composition, in particular for use as a lubricant, which comprises at least one (poly)urea powder according to the invention, at least one base oil and at least one further thickening agent or thickener. Typical further thickening agents or thickeners used in lubricating grease formulations include, in particular, the alkali metal soaps, clays, polymers, asbestos, carbon black, silica gels and aluminium complexes.

The so-called soap greases are preferred according to the invention. These are, in particular, metal salts of, in particular, monobasic, optionally substituted, preferably higher (>C8) carboxylic acids, it also being possible to use mixtures of metal salts of the carboxylic acids. These are, in particular, metal salts of carboxylic acids with alkali metals and alkaline earth metals, such as sodium, potassium, lithium, calcium, magnesium, barium or strontium, and also with other metals, such as, for example, aluminium and zinc. Lithium and calcium soaps are the most widely used. Simple soap lubricating greases are formed from the alkali metal salts of long-chain fatty acids (at least C8), lithium 12-hydroxystearate, the most frequent, being formed from 12-hydroxystearic acid, lithium hydroxide monohydrate and mineral oil. Complex soap fats are also widely employed and include metal salts of a mixture of organic acids. A typical complex soap lubricating grease which is employed nowadays is a complex lithium soap lubricating grease which is prepared from 12-hydroxystearic acid, lithium hydroxide monohydrate, azelaic acid and mineral oil. The lithium soaps are described in many patents, including U.S. Pat. No. 3,758,407, U.S. Pat. No. 3,791,973, U.S. Pat. No. 3,929,651 and U.S. Pat. No. 4,392,967, in which examples are also given.

According to the invention, the weight ratio of the weight of soap greases to weight of polyureas can be from 100:1 to 1:100. The attractiveness of the (poly)urea powders prepared according to the invention in a mixture with soap greases is in particular that in contrast to the PU greases prepared via in situ processes, in this case the isolated dry polyurea powder can be introduced into the soap grease formulations and the properties thereof can be influenced there in a controlled manner. Experiments show that by admixing 2% of polyurea grease to lithium soap greases, a reduction in the penetration and therefore an improvement in the consistency of the grease are surprisingly achieved. Furthermore, the drop point is increased compared with the pure lithium soap grease. The present invention is illustrated by the following examples.

### EXAMPLES

Polyurea 1:

128.43 g of a methylene-4,4′-diphenyl-diisocyanate having an NCO content of 32.68% are added to a mixture of 44.58 g diethyltolylenediamine and 99.3 g coconut fatty amine in 1,350 g petroleum ether, with constant stirring.

When the reaction has ended, the solvent of the suspension formed is removed from the reaction under exposure to shearing forces, and the powder formed is dried under an applied vacuum.

A 15% suspension of the resulting powder in naphthenic base mineral oil is stirred at approx. 150° C. for 1 h, cooled and then homogenized 3× on a triple roll mill. The drop point and consistency of the resulting grease are determined. A grease which has been produced from polyurea powder of identical composition and the same base oil serves as a comparison. The powder on which the reference grease is based was prepared in a kneading extruder and then ground in the conventional manner.

Results:

| | Drop point | Worked penetration | | |
|---|---|---|---|---|
| | [DIN 51580] | Pᵤ | P_{w, 60} | P_{w, 60,000} |
| Polyurea grease, reactor | 212° C. | 204 | 200 | 204 |
| (invention) | | | | |
| Reference grease, kneading | 210° C. | 242 | 242 | 259 |
| extruder | | | | |

The consistency of a grease is determined by determining the penetration of a cone according to ISO 2137 on a sample of grease. The penetration of the cone corresponds here to the depth of penetration of a cylindrical cone into the grease sample after 5 s, measured in 1/10 mm,—the higher the value, the greater the depth of penetration, the lower the grease consistency. A distinction is made here between the unworked penetration Pu and the worked penetration Pw,60 or Pw,60,000. The unworked penetration is determined on untreated grease. The worked penetration is determined after the sample has been worked with 60 strokes (Pw,60) or 60,000 strokes (Pw,60,000). The difference between the two worked penetrations represents a measure, proven in practice, of the stability of the grease under permanent loading. The smaller the difference, the more resistant the grease sample to loading.

Polyurea 2:

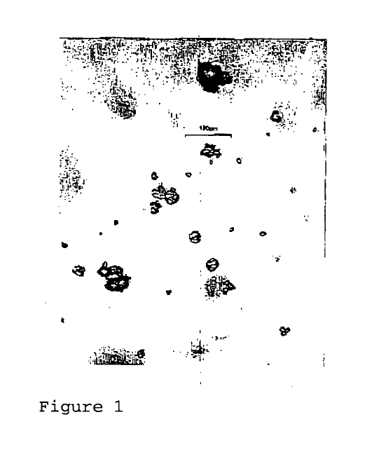

2 mol 2,4-/2,6-tolylene-diisocyanate were added to a mixture of 1 mol 1,6-hexamethylenediamine and 2 mol stearylamine in ethyl acetate. After the reaction had ended, the solvent of the suspension formed is removed from the reaction under exposure to shearing forces. The pulverulent polyurea 2 obtained is dried in vacuo. The light microscopy photograph (FIG. 1) shows that the particle diameter is significantly below 100 μm. This is confirmed by a particle size analysis by means of coherent light scattering. The weight-average of the measurement is D[v, 0.5]=30.79 μm.

A 15% suspension of the dried polyurea 2 in naphthenic base oil is stirred at 170° C. for 1 h and then cooled and homogenized 3× on a triple roll mill. The consistency is determined in comparison with a reference grease of identical composition prepared “in situ”.

Results:

| | Worked penetration | | |
|---|---|---|---|
| | Pᵤ | P_{w, 60} | P_{w, 60,000} |
| Polyurea grease, reactor | 186 | 196 | 267 |
| (invention) | | | |
| Reference grease, | 196 | 200 | 298 |
| “in situ” process | | | |

Mixtures of lithium soap fats with polyurea powder prepared according to the invention.

It was to be determined whether admixing of polyurea powder prepared according to the invention leads to a change in the penetration and drop point of commercially obtainable lithium soap greases. For this, three different commercially obtainable lithium soap greases were investigated with and without the addition of polyurea powder. The lithium soap greases were heated to 170° C., temperature-controlled for one hour and then passed 3× over a roll mill with and without addition of polyurea powder. The results were as follows:

| | Pu ( 1/10 mm) | Drop point (° C.) |
|---|---|---|
| Experiment 1 | | |
| Li 12 OH stear. base grease P | 270 | 187 |
| 1034 untreated | | |
| Li 12 OH stear. base grease P | 215 | 188 |
| 1034 1 h 270° C.; 3× roll mill | | |
| Li 12 OH stear. base grease P | 196 | 203 |
| 1034 + 2% polyurea powder | | |
| 1 h 170° C.; 3× roll mill | | |
| Experiment 2 | | |
| Li grease Shell L11257 untreated | 235 | 184 |
| Li grease Shell L11257 | 200 | 184 |
| 1 h 170° C.; 3× roll mill | | |
| Li grease Shell L11257 | 194 | 186 |
| 2% polyurea powder | | |
| 1 h 170° C.; 3× roll mill | | |
| Experiment 3 | | |
| Texaco Li 12-OH grease | 238 | 197 |
| L10195 untreated | | |
| Texaco Li 12-OH grease L10195 | 206 | 198 |
| 1 h 170° C.; 3× roll mill | | |
| Texaco Li 12-OH grease | 198 | 203 |
| L10195 + 2% polyurea powder | | |
| 1 H 170° C.; 3× roll mill | | |

The experiments show that, surprisingly, a reduction in the penetration and therefore an improvement in the consistency of the grease is achieved by admixing 2% polyurea grease to lithium soap greases. Furthermore, the drop point is increased compared with the pure lithium soap grease.

1. Process for the preparation of a (poly)urea powder, characterized in that at least one isocyanate is reacted with at least one amine in at least one solvent in a reactor and the (poly)urea formed is dried in the said reactor under exposure to shearing forces to form a (poly)urea powder.

2. Process according to claim 1, characterized in that the (poly)urea is chosen from a monourea compound and a polyurea compound.

3. Process for the preparation of a polyurea powder according to claim 1 or 2, characterized in that at least one polyisocyanate is reacted with at least one polyamine and optionally with at least one monoamine in at least one solvent in a reactor and the polyurea formed is dried in the said reactor under exposure to shearing forces to form a polyurea powder.

4. Process according to claim 3, characterized in that the weight ratio of the total weight of polyisocyanate and mono- and polyamine to the total weight of the solvents is from 10% to 50%.

5. Process according to one of claims 1 to 4, characterized in that the solvent is chosen from organic solvents.

6. Process according to one of claims 1 to 5, characterized in that the solvent is chosen from organic solvents which are chosen from the group which consists of: optionally substituted straight-chain, branched or cyclic, aliphatic or aromatic hydrocarbons.

7. Process according to one of claims 3 to 5, wherein the polyisocyanates are chosen from the group which consists of: 2,4′- and 4,4′-diisocyanatodiphenylmethane (MDI), hexamethylene-diisocyanate (HDI), toluene-diisocyanate (TDI), polymethylenepolyphenyl isocyanate (PMDI), naphthylene-diisocyanate (NDI), dicyclohexyl-4,4′-diisocyanate and isophorone-diisocyanate (IPDI).

8. Process according to one of claims 1 to 7, wherein the mono- and polyamines are chosen from the group which consists of:
ethylenediamine, 1,2-propylenediamine, 1,3-propylenediamine, diethylenetriamine, triethylenetetraamine, tetraethylenepentamine, pentaethylenehexamine, polyethyleneimine having molecular weights of between 250 and 10,000, 2,4-diaminotoluene and 2,6-diaminotoluene, bis-(4-amino-phenyl)-methane, polymethylenepolyphenylamine and polyethers containing amino groups, having a content of primary or secondary amino groups of from 1 to 8 mmol/g and molecular weights of between 250 and 2,000, phenylenediamine, diethyltoluylenediamine, 2-methylpentamethylenediamine and butylamine, hexylamine, octylamine, stearylamine, oleylamine, tridecylamine, coconut fatty amine, aniline, isopropylaniline, N,N-diethylaniline, p-toluidine, cyclohexylamine and dioctyldiphenylamine.

9. Process according to one of claims 1 to 8, characterized in that in addition to mono- and polyamines, further polyfunctional compounds which are reactive towards isocyanates are used.

10. Process according to one of claims 1 to 9, characterized in that the (poly)urea powder formed comprises polyurea having a weight-average molecular weight of from 500 to 20,000, determined by gel permeation chromatography against polystyrene as the standard, of from 200 to 2,000,000.

11. Process according to one of claims 1 to 10, characterized in that the reaction of the polyisocyanate with the mono- or polyamine is carried out at a temperature in the range of from 20 to 120° C.

12. Process according to one of claims 1 to 11, characterized in that the drying is carried out at a temperature in the range of from 40 to 80° C.

13. Process according to one of claims 1 to 12, characterized in that the drying is carried out under a pressure in the range of from 100 to 300 mbar.

14. Process according to one of claims 1 to 13, characterized in that the shearing forces exerted in the reactor are from 1 to 10⁴ s⁻¹.

15. Process according to one of claims 1 to 14, characterized in that the reactor is chosen from horizontal single-shaft mixers.

16. Process according to one of claims 1 to 15, characterized in that the (poly)urea powder obtained has an average particle size of less than 150 μm.

17. Process according to claim 1 to 16, characterized in that the (poly)urea powder obtained has an average particle size of less than 100 μm.

18. Process according to claim 16 or 17, characterized in that the (poly)urea powder obtained has an average particle size of more than 20 μm.

19. Process according to claim 1 to 18, wherein more than 90% of the particles of the (poly)urea powder obtained have a particle size of less than 100 μm.

20. (Poly)urea powder, obtainable according to one of claims 1 to 19.

21. (Poly)urea powder which has an average particle diameter of from 20 to 100 μm.

22. (Poly)urea powder according to claim 20 or 21, which has a content of volatile constituents, such as solvents, of less than 0.5 wt. %.

23. (Poly)urea powder according to one of claims 20 to 22, which has a specific surface area of more than 15 m²/g (measured by Hg porosimetry).

24. Process for the preparation of a composition, which comprises suspending the (poly)urea powders obtained according to one of claims 1 to 19 in at least one base oil.

25. Process according to claim 24, wherein the suspension of the (poly)urea powder in at least one base oil is subjected to treatment in a high-pressure homogenizer.

26. Process according to claim 25, characterized in that the base oil is chosen from the group which consists of mineral oils and synthetic or natural oils.

27. Process according to claim 24, 25 or 26, wherein the amount of (poly)urea powder is from 2 to 25 wt. %, based on the total amount of the base oil.

28. Process according to one of claims 24 to 27, wherein at least one further conventional auxiliary substance and additive for lubricants is admixed.

29. Process according to one of claims 24 to 28, wherein at least one further thickener is admixed.

30. Use of the (poly)urea powders obtained according to one of claims 1 to 19 as thickening agents.

31. Use of the (poly)urea powders obtained according to one of claims 1 to 19 in lubricants.

32. Use of the composition obtained according to one of claims 24 to 29 as a lubricant, paint, lacquer, adhesive, paste, solution etc.
